(19) United States
(12) Patent Application Publication
(10) Pub. No.: US 2024/0428632 A1
(43) Pub. Date: Dec. 26, 2024

(54) PROCESS OF ENCODING KEYCARDS, LOCAL SERVER AND SYSTEM THEREFOR

(71) Applicant: DORMAKABA CANADA INC., Montréal (CA)

(72) Inventors: Marc GOULET, Montréal (CA); Michel LESSARD, Montréal (CA)

(21) Appl. No.: 18/338,891

(22) Filed: Jun. 21, 2023

(51) Int. Cl. G07C 9/00; G06K 7/10; G06Q 10/02; G06Q 50/12; G07C 9/20

(52) U.S. Cl. CPC G07C 9/00658; G06K 7/10297; G06Q 10/02; G06Q 50/12; G07C 9/00904; G07C 9/20

(57) ABSTRACT

A local server can be provided at the premises. The local server can monitor connectivity of workstations to a cloud server. When the workstations are connected to the cloud server, they may request the encoding of keycards to the cloud server, and the cloud server may command the encoders to proceed with the encoding of the keycards accordingly. When detecting an interruption in the connectivity, the local server can enable the local creation of new bookings. This can include storing booking data stemming from the new booking into the memory; and encoding one or more keycard via a given one of the encoders, including granting the one or more keycards access, for the access period, to one or more of the electronic locks corresponding to the one or more of the units. When detecting the connection, the local creation of new bookings can be disabled.

### BACKGROUND

In recent years, web-based software tools, alternately referred to as cloud-based software tools, have become more and more frequently used in hoteling, multi-housing rental and the like. Using one of such tools commonly referred to as a property management system (PMS), users can connect to a cloud-based software tool via a telecommunications network, such as the Internet, to perform tasks such as booking reservations (attributing units to guests based on a given stay period). Another one of such tools is an access management system (AMS) via which users can connect to a cloud-based software tool to perform functions such as encoding RFID keycards via encoders at the premises, in relation with the booked reservations. Notwithstanding the significant advantages which can stem from using cloud-based software tools in such operations, one of the factors which limits the convenience of use of such tools is the impact that loss of connectivity may have on the operations at the premises. Accordingly, there remained room for improvement.

### SUMMARY

In accordance with one aspect, there is provided a local server located at a premises, the premises having at least one unit, the premises having at least one electronic lock, the premises having at least one workstation, the premises having at least one encoder, the local server comprising a memory and a processor, the memory having stored thereon configuration data for the premises and instructions executable by the processor to: monitor a connectivity to a cloud server to detect an interruption in the connectivity and to detect a connection in the connectivity; when detecting the interruption, enable local creation of at least one booking including, for each of the at least one booking: creating the at least one booking based on the configuration data and based on inputs received from a given one of the at least one workstation, including storing booking data into the memory, the booking data comprising an access period at the premises; and encoding at least one access device via at least one encoders, including granting the at least one access device access, for the access period, to at least one of the at least one unit; and when detecting the connection, disable local creation of at least one booking.

It may be provided that the at least one workstation includes a plurality of workstations and wherein the at least one encoder includes a plurality of encoders, wherein the instructions are executable to repeat the creating and encoding for a plurality of bookings based on the configuration data and inputs from different ones of the plurality of workstations, including adding the booking data generated by the creation of each one of the plurality of bookings to a table in the memory, and repeating the encoding for each one of the plurality of bookings via different ones of the plurality of encoders, the different ones of the plurality of encoders associated to different ones of the plurality of workstations.

It may include, for a first one of the plurality of bookings, creating the table and including the corresponding booking data as a first line of the table.

It may be provided that the encoding includes determining which one of the plurality of encoders to send an encoding command to based on association data, the association data associating different ones of the plurality of encoders to different ones of the plurality of workstations, the association data forming part of the configuration data.

It may be provided that the instructions are further executable to, when detecting the interruption, enable consultation of the booking data via the at least one workstation.

It may be provided that the instructions are further executable to, when detecting the interruption, enable the encoding of at least one replacement access device via the at least one encoder.

It may be provided that the instructions are further executable to, when detecting the interruption, enable modification of the booking data via the at least one workstation.

It may be provided that the instructions are further executable to, when detecting the connection, communicating the booking data to the cloud server via a telecommunications network.

It may be provided that the instructions are further executable to delete the booking data from the local server subsequently to said communicating the booking data to the cloud server.

It may be provided that said creating includes, for each one of the at least one booking, storing key data in association with corresponding booking data in the memory; and wherein the instructions are further executable by the processor to, when detecting the connection, communicating the key data to the cloud server via the telecommunications network.

It may be provided that the key data includes an identifier of the at least one access device, an identifier of a staff member logged into the local server and responsible for the encoding, and date information at which the encoding was performed.

It may be provided that said granting further includes granting the at least one access device access, for the access period, to at least one of a floor, a pool, a gym, a food area, a conference area, and a terrace.

It may be provided that said enabling the local creation of at least one booking further includes receiving a login request from the given one of the at least one workstation over a local area network, authenticating the login request against the configuration data, and granting access to the creating and encoding contingent upon the authenticating the login request.

It may include, for each one of the at least one booking, receiving a confirmation of a success of the encoding from the given one of the at least one encoder via a local area network, and communicating the confirmation of the success of the encoding to the given one of the at least one workstation via the local area network.

It may be provided that the instructions are further executable to copy cloud booking data stemming from previous bookings from the cloud server to the memory, including updating the cloud booking data in the memory to reflect changes in the cloud booking data at the cloud server, said storing booking data including forming offline booking data including adding the booking data to the cloud booking data in the memory.

It may be provided that the encoding includes encoding the at least one access device at a level which is different from when the at least one access device is encoded via the cloud server.

It may be provided that the access credentials released by the local server are first level access credentials, said access credentials released by the cloud server are second level access credentials, the second level access credentials being different from the first level access credentials, wherein presenting one of the first level access credentials at one of the electronic locks blocks the access at this one of the electronic locks for one of the second level access credentials.

It may be provided that the at least one access device comprises at least one keycard.

It may be provided that the at least one access device comprises at least one mobile credential.

It may be provided that the instructions are further executable to translate TCP/IP messages received from a PMS server to REST API messages, and to send the REST API messages.

In accordance with another aspect, there is provided: a method of encoding access devices for controlling access to at least one unit located at a premises, the premises having at least one workstation and at least one encoder for encoding the at least one access device, the method comprising: at the premises, monitoring a connectivity to a cloud server to detect an interruption in the connectivity and to detect a connection in the connectivity; when detecting the interruption, enabling local creation of at least one booking including, for each of the at least one booking: creating the at least one booking based on a configuration of the premises and based on inputs received from a given one of the at least one workstation, including storing booking data into a memory, the booking data comprising an access period at the premises; and encoding at least one of the access devices via a given one of the at least one encoder, including granting the at least one access device access, for the access period, to at least one of the units; and when detecting the connection, disabling the local creation of the at least one booking.

It may be provided that the creating includes, for each one of the at least one booking, storing key data in association with corresponding booking data in the memory; further comprising, when detecting the connection, communicating the key data and the booking data to the cloud server via a telecommunications network.

In accordance with another aspect, there is provided: a method of releasing access credentials for providing access to units controlled by electronic locks located at a premises, the premises having a workstation, the method comprising: at the premises, monitoring connectivity to a cloud server to detect an interruption in the connectivity and to detect a connection in the connectivity; when detecting the interruption, enabling local creation of bookings by a local server, the local server having a memory and configuration data stored in the memory, including, for each of the bookings: creating the booking based on the configuration data and based on inputs received from the workstation, including storing booking data stemming from the booking into the memory, the booking data including an access period at one or more of the units; releasing access credentials, including granting access, for the access period, to the one or more of the units controlled by one or more of the electronic locks; and when detecting the connection, disabling the local creation of bookings.

It may be provided that the releasing access credentials includes commanding an encoder located at the premises to encode one or more keycards with the access credentials.

It may be provided that the releasing access credentials includes transmitting the access credentials to a customer device.

It may include a cloud server releasing access credentials over a telecommunications network prior to detecting the interruption in the connectivity.

It may be provided that the access credentials released by the local server are first level access credentials, said access credentials released by the cloud server are second level access credentials, the second level access credentials being different from the first level access credentials, wherein presenting one of the first level access credentials at one of the electronic locks blocks the access at this one of the electronic locks for one of the second level access credentials.

It may include copying cloud booking data associated to the encoding by the cloud server to the memory of the local server, including updating the cloud booking data in the memory to reflect changes in the cloud booking data at the cloud server, said storing booking data including adding the booking data to the cloud booking data in the memory to form offline booking data.

It may include, when detecting the connection, the local server uploading the offline booking data to the cloud server.

All technical implementation details and advantages described with respect to a particular aspect of the present invention are self-evidently mutatis mutandis applicable for all other aspects of the present invention.

Many further features and combinations thereof concerning the present improvements will appear to those skilled in the art following a reading of the instant disclosure.

### DESCRIPTION OF THE FIGURES

In the figures,

FIG. 1 is a schematic view of an example of computerized systems used in the management of premises;

FIG. 2 is a schematic view of an example of an electronic lock;

FIGS. 3A to 3E are successive graphical user interfaces used to collect user inputs in an example process of encoding a keycard;

FIG. 4A is a chart showing a first example process of encoding a keycard;

FIG. 4B is a chart showing a second example process of encoding a keycard;

FIG. 5 is a schematic illustration depicting the encoding of keycards at different levels by the cloud server and by the local server; and

FIG. 6 is a schematic view of a computer.

### DETAILED DESCRIPTION

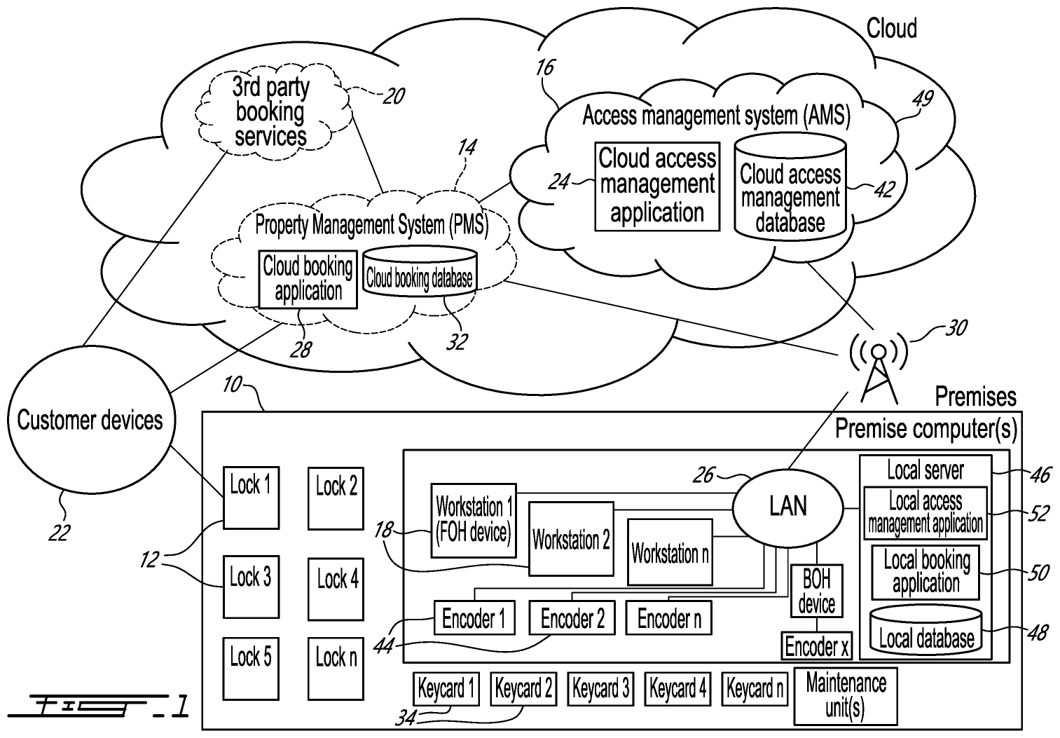

FIG. 1 shows an example embodiment of computerized systems used in the management of one or more premises 10 having a number of short or medium term units associated to corresponding electronic locks 12, such as hoteling premises or rental premises for instance. More specifically, this example embodiment provides an example of two such systems, including a property management system 14 (PMS) and an access management system 16 (AMS). Such systems 14, 16 are typically configured to allow the management of many premises 10 having different configurations, a single one of which is shown in FIG. 1 as an example.

Such computerized systems 14, 16 may involve a number of workstations 18 used by staff at the premises to perform a plurality of potential functions, such creating, confirming, modifying, or canceling a booking, encoding a keycard, and encoding an electronic key. Functions associated with a booking can be performed via the property management system 14 (PMS). Several service providers offer PMS services. Functions associated with access management (e.g. encoding a keycard and encoding an electronic key) are typically performed via the access management system 16 (AMS). The AMS provider can be dormakaba™ for instance. The AMS provider is typically also the provider of the electronic locks 12 which control the access to the units, to common areas, to staff areas, and other areas of the premises, which the keycards or electronic keys are designed to selectively grant access to. Certain AMS operations may use data obtainable from the PMS 14. Similarly to the PMS services, different service providers may offer AMS services, and the entities which offer the AMS services are typically different than the entities offering the PMS services, leading in some cases to a need for compatibility between different systems which may need to adapt as systems change and evolve over time. Such compatibility, while allowing to remain up to date with most recent technological features, may be more convenient to offer in the form of cloud-based software tools, or Software-As-A-Service (SAAS) model, which evolve over time, than as software permanently installed at the premises. Moreover, it has become more and more frequent to allow guests themselves act as users for the booking operations, which may be offered directly by a PMS 14, or via a third party booking service 20. Third party booking services 20 may be configured to interface with the PMS 14. In such cases, customers may shop for a stay over the Internet with their own customer devices 22 such as laptops, desktops, tablets, smartphones, etc, and book their stay via a web-based booking service such as a PMS 14 booking service or a third party booking service 20.

In this general context, it can be convenient for the key assignment application 24 to be provided in the form of a cloud-based service. This application will be referred to as the cloud key assignment application 24 in this specification. The cloud key assignment application 24 may include functions such as key encoding functionalities and associated user credential management functionalities, and can be adapted to manage a large number of premises 10. In the context of the computerized system, premises can be uniquely identifiable and distinguishable from one another by attributing each premise a unique premise identifier (which may alternately be referred to as a tenant identifier in some embodiments). The relevant configuration elements about each premises can be encoded in the form of configuration data associated to each premise identifier (e.g. in the form of a table having a plurality of lines, with each line including a premise identifier and the associated configuration data, but other data structures than tables may alternately be deemed convenient in some embodiments). The configuration data may be configured at an initial configuration step or updated as changes or corrections are required. The configuration data can include building ID(s) identifying one or more building of the premises, floor ID(s) for different buildings, guest room ID(s) for different floors, guest common area ID(s) (e.g. gym, pool, terrace, food area, conference area), suite ID(s), suite common inner door ID(s), etc. The workstations 18 at the premises are typically integrated to a local area network 26 (LAN), and communicate with the cloud applications 24, 28 via a telecommunications network such as the Internet.

While the AMS 16 is typically more concerned about configuration details associated to access, the PMS 14, on the other hand, is typically more concerned about configuration details associated to the guest experience and may be used exclusively to manage some types of data pertaining to unit details which may affect pricing (e.g. size and quantity of beds, smoking or non-smoking, stay includes access to a given common area or not, etc), which the AMS 16 may not be concerned with.

Accordingly, when a staff member at a given workstation 18 of a given premise 10 wishes to encode one or more keycards for a given guest, the staff member may, via a computerized workstation located at the premises (often referred to as a Front-of-House—FOH—device), access the PMS, via a telecommunications network 30 such as the Internet, to either create a new booking for the given guest, confirm an existing booking for that guest, modify an existing booking, or cancel an existing booking (e.g. via a cloud booking application 28). In the context of the computerized environment, this can involve the PMS 14 maintaining a cloud-based booking database 32 which can capture the associated PMS booking data. To help visualisation by a human being, this cloud booking database 32 can be in the form of a table for instance, which may be edited to add a row when creating a new booking, edit a row when modifying an existing booking, or delete a row when canceling an existing booking, to name one example. The process of creating a first row of the table can be considered to constitute a step of the creation of the table which may be performed prior to adding additional rows associated to additional bookings. Booking typically involves associating data pertaining to the stay (e.g. room or rooms, stay period, common area accesses, etc.) to an identifier of the guest. Booking typically involves the creation of a guest profile upstream of the selection of the stay details, to which the details of the stay can be linked.

A simplistic example of PMS booking data in such a format is presented in the table below, where each guest is attributed a guest ID, one or more room ID, a stay period, and an indication of whether or not the details of the stay include access to a common area.

Example Booking data

| Guest ID | Room ID | stay period | Common area |
|---|---|---|---|
| 4432 | 302 | 04/12-04/15 | Y |
| 4464 | 203 | 04/14-04/15 | N |
| 4465 | 412; 414 | 04/14-04/18 | Y |
| . . . | . . . | . . . | . . . |

As evoked above, the PMS booking data may alternately be read or edited by inputs received from other computers than workstations 18, such as via a third party booking system 20 for instance, with which the customers may directly interface via their own devices 22 (e.g. desktops, laptops, tablets or smartphones). In some cases, a PMS 14 may offer the functionality of allowing customers to interface directly with their web-based platform. The customers can alternately access the PMS 14 via the premises, such as by performing an in-person booking or a telephone booking via a staff member and workstation 18 located at the premises 10. The PMS 14 also typically manages payment functions.

When a guest (or group) arrives at the premises 10 for his/her/their stay, and the booking is done either at the time of arrival, or has been done beforehand, another process to be performed before the guest or group can begin fully enjoying their stay is the granting of access to the associated electronic locks 12. This process can be performed via the AMS 16 and can involve encoding an electronic device such as a keycard with access credentials. This can be done in different ways. The most common way of providing the access credentials is by encoding keycards 34, which can be done at the time the guest or group arrives at the premises 10. In some cases, an electronic key can be provided to a guest device 22, in addition to, or as an alternative to one or more keycard 34, and in some cases, such an electronic key 22 may allow the guest or group to avoid the front desk and go directly to their units. Keycards 34 and electronic keys 22 are configured to interface via connectivity features of the electronic locks 12.

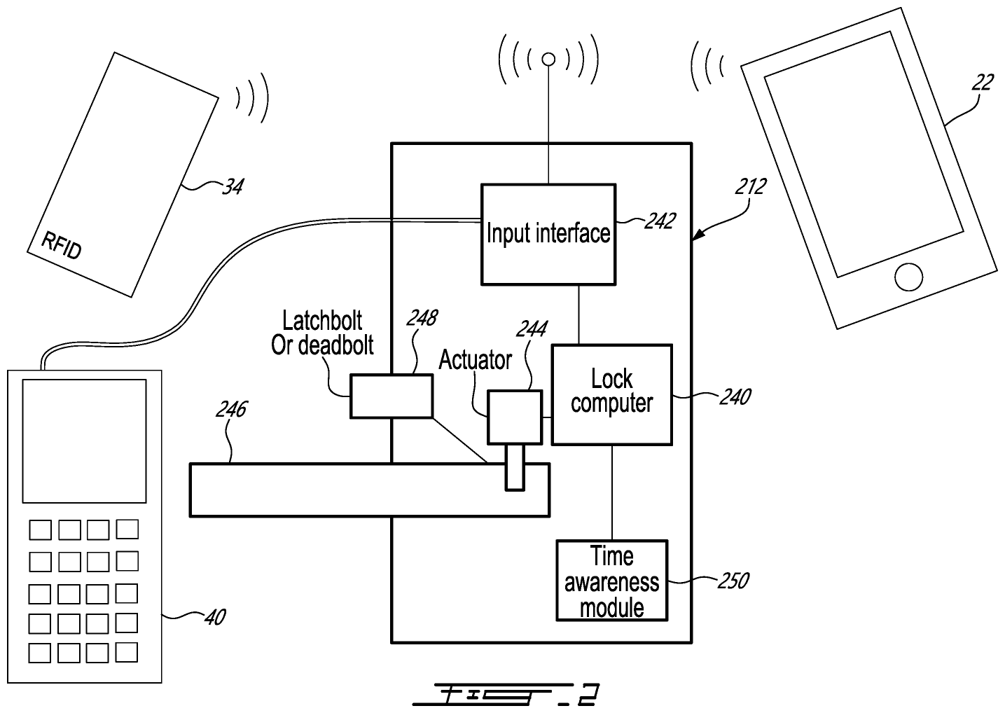

FIG. 2 schematizes one possible embodiment of an electronic lock 212. The electronic lock 212 can be seen to have a lock computer 240 configured to receive an input from an input interface 242 and to control an actuator 244 which can selectively block or unblock a handle 246 which controls a bolt, or pull or push a deadbolt 248, or block or unblock a latch bolt 248, for instance, in this example. The electronic lock 212 can further have a time awareness module 250, such as an internal clock, accessible by the lock computer 240 to determine whether any time-related authorization conditions (e.g. access period) are met or not. It will be understood that this is but one example of an embodiment of an electronic lock 12, and that many alternate configurations are possible in other embodiments. In particular, it will be understood that the different electronic elements or computerized functionalities of the electronic lock 12 can be incorporated in a same or distributed in different housings, and be configured for communicating with one another in a wired or wireless manner. The embodiment presented in FIG. 2 is an example relatively typical for the North American market where the lock computer 240, input interface 242, time awareness module 250, and actuator 244 are all integrated to a single housing of an electronic lock 212.

It will be noted that depending on the embodiment, the input interface of the electronic lock 12 may have different input features. In the example shown in FIG. 2, the electronic lock 212 is configured to interface with the keycards 34 via RFID, and optionally to interface with guest devices 22 (bearing electronic keys) via Bluetooth™ low energy (BLE) for instance. In such an embodiment, the keycards 34 can be seen as passive electronic devices. The electronic locks 212 are also configured to interface with a maintenance unit 40 via a wired connection, such as USB. These details are provided solely for the sake of providing examples, and that in alternate embodiments, different interfacing technologies (e.g. Wifi, wireless access point (AP), near-field communication (NFC)) may be used with different interfacing devices and the details are left entirely to the designer of the electronic lock 12.

Returning to FIG. 1, to perform the step of granting guest access to the electronic locks 12, the staff at the premises 10 may proceed to access the AMS 16. More specifically, the staff may control a computerized workstation 18 at the premises 10 to access a cloud-based key assignment application 24, running in the cloud computerized environment, via the telecommunications network 30 such as the Internet. The AMS 16 needs data to know which lock 12 to grant access to, and for which access period. Obtaining this data can involve the use of configuration data stored in the cloud database 42, inputs received from the workstation 18, and/or, if available, booking data from the PMS 14. For instance, it may be desired for the access period to correspond to the booking period. Alternately, the access period may not correspond to the booking period, which may be the case, for instance, for access to an electronic lock which controls the access to a common area to which the guest is only attributed limited access to. The physical step of encoding a keycard 34 with the access credentials can be performed by using an electronic device referred to as an encoder 44. Typically, each workstation 18 has a dedicated encoder 44. However, the step of performing the encoding of the keycard 34 with the encoder 44 may not be performed directly between the workstation 18 and its associated encoder 44, but rather via the cloud key assignment application 24 which controls the encoder 44 based namely on the inputs received from the workstation 18. Accordingly, the encoder 44 may not be connected directly to the associated workstation 18, but rather connected to the LAN 26. When controlled to perform the encoding function, the integrated functionalities of the encoder 44 can confirm whether or not the encoding operation was successful to the cloud key assignment application 24, which may, in turn, confirm to the workstation 18 whether the operation was successful or not. The cloud key assignment application 24 may be able to determine which workstation 18 is the source of an encoding request based on a login or authenticating step having been previously performed. The cloud key assignment application 24 may be able to determine which encoder 44 is associated to which workstation 18 based on association data which may be included as part of the configuration data, in the cloud access management database 42.

Performing the encoding operation may involve generating key data which the AMS 16 may be configured to keep track of. This can be performed via the cloud access management database 42. In one example to help visualization by a human being, the key data can be formatted as a table, with different rows corresponding to different encoding operations. Each row can associate information such as which keycard was encoded, the IDs of the electronic locks to which the access was granted, the access period (which may correspond to the stay period), who is at the source of the encoding operation (which staff credentials were used to log in), when the encoding was performed, by which encoder, etc. One example of key data in table format is provided below for the purpose of illustration.

Example Key data

| Room | Access | Common | | Keycard | Encoded | | |
|---|---|---|---|---|---|---|---|
| ID | period | areas | E-key? | ID | by | Encoding time | Encoder ID |
| 302 | April 2012- | Y | N | 125512 | Matthias | April 2009; 16 h 42 | 3 |
| | April 2015 | | | | L. | | |
| 203 | April 2014- | N | N | 125513 | Naomy | April 2012; 13 h 05 | 1 |
| | April 2015 | | | | P. | | |
| 412; | April 2014- | Y | Y | — | — | — | — |
| 414 | April 2018 | | | | | | |
| . . . | . . . | . . . | . . . | . . . | . . . | . . . | . . . |

Despite the advantages of performing the key assignment functions via the cloud key assignment application 24 and/or cloud access management database 42, one of the disadvantages of this approach is that in the event of an interruption in the connectivity between the workstations 18 and the cloud server 49 (e.g. cloud key assignment application 24), the staff may no longer be able to perform these functions, which may be particularly inconvenient if it happens at a time of high demand.

It was found that the implementation of some functions on a local server 46 could help in alleviating or overcoming such inconveniences, however there were several challenges to implementing a successful approach within the limitations and requirements of the overall context.

One example which can be useful in at least some embodiments will now be described. In this example, certain functionalities for use in the context of encoding keycards 34 are implemented to a local server 46 and can be used as a fallback in the event of a loss of connectivity between the workstations 18 and the cloud server 49 to limit or avoid any disruptions which the loss of connectivity may otherwise have caused. The local server 46 can be provided by the AMS provider. The local server 46 may be a computer, and have hardware elements, such as a processor and memory, located entirely at the premises 10. The local server 46 may be connected to local devices, such as the workstations 18 and the encoders 44, via the Local Area Network 26 (LAN). The LAN 26 can be based on wired, e.g. Ethernet, connections, on wireless connections, or on a mix of wired and wireless connections, though wired connections may be preferred in some embodiments. The local server 46 can have a first functionality, implemented by instructions stored in the memory and executable by the processor, of monitoring connectivity of the local workstations 18 to the cloud server 49. The local server 46 can have other functionalities referred to as fallback functionalities. The local server 46 can disable its fallback functionalities when a connection in the connectivity between the local workstations 18 and the cloud server 49 is detected, and to enable its fallback functionalities only when an interruption in the connectivity between the local workstations 18 and the cloud server 49 is detected. Detecting the status of the connectivity of the workstations 18, or more generally of the premises 10, to the cloud server 49 can be performed in various ways. In one example, it can be determined by monitoring its (the local server's 46) own connectivity to the cloud server 49, as it may be presumable that the workstations 18, and the premises 10 in general such as the LAN 26, have lost their connectivity to the cloud server 49 when the local server 46 has lost its connectivity to the cloud server 49.

The monitoring of the connectivity of the workstations 18 to the cloud server 49 by the local server 46 can be performed in different ways in different embodiments. It can be performed directly or indirectly. For instance, in one embodiment, the workstations 18, and/or the encoders 44 may send a signal to the local server 46 that they have lost connectivity to the cloud server 49, in which case the local server 46 can monitor the connectivity of the workstations 18 based on whether it has received or not received such a signal. In an alternate embodiment, the local server 46 may monitor its own connectivity to the cloud server 49, and may infer that the workstations 18 have lost connectivity to the cloud server 49 in the event where the local server 46 detects that it has lost connectivity to the cloud server 49. In yet another example, the local server 46 may monitor the connectivity of the local area network 26, or of an edge device of the local area network 26, to the cloud server 49, and may infer that the workstations 18 have lost connectivity to the cloud server 49 in the event where the local server 46 detects that the local area network 26 or edge device thereof has lost connectivity to the cloud server 49.

The fallback functionalities of the local server 46 may pertain to the local creation of new bookings. To perform the fallback functionalities, the local server 46 may need a copy of the configuration data which may be stored in the cloud access management database 42. The configuration data may have been pushed from the cloud server 49 to the local server 46 beforehand, such as at the time of initial configuration of the system for the premises 10, or at the time of performing an update to the configuration for the premises 10. The configuration data can be copied into the memory of the local server 46, such as in a local database 48. The configuration data can include building ID(s) identifying one or more building of the premises, floor ID(s) for different buildings, guest room ID(s) for different floors, guest common area ID(s) (e.g. gym, pool, terrace, food area, conference area), suite ID(s), suite common inner door ID(s), etc.

The fallback functionalities can include a) a functionality of creating a new booking, and b) a functionality of encoding access devices with access credentials via the encoders. In an embodiment, the access devices are keycards (e.g. RFID keycards) and the encoders can be referred to as keycard encoders. In another embodiment, the encoder may be configured to interface with one or more type of access devices, such as keycards, wrist bands, and fobs. In another embodiment, the access devices include mobile devices, and releasing access credentials in the process of granting access can include transmitting access credentials to a customer device, such as a mobile device for instance, in which latter case the access credentials can be referred to as mobile credentials. The functionalities can be provided in the form of instructions executable by the processor (i.e. as software) stored in the memory. The software elements associated to functionality a) can be referred to as a local (or fallback) booking application 50 and the software elements associated to functionality b) can be referred to as a local access management application 52.

An interruption in the connectivity of the workstations 18 to the cloud server 49 may occur due to different reasons, such as a telecommunications network 30 failure, a cloud server 49 failure, a LAN 26 connectivity failure, or a planned (e.g. maintenance) interruption of the cloud server 49 for instance.

Upon detecting the interruption in the connectivity, the local server 46 may enable the fallback functionalities. In other words, it may allow the workstations 18 to interface to its software functionalities via the LAN 26, and via a local authentication process. When a connection in the connectivity is detected, the local server 46 may disable the fallback functionalities. In other words, it may disconnect itself from the LAN connection to the workstations 18 or otherwise prevent new bookings from being generated by the fallback functionalities.

When enabling the fallback functionalities, the local server 46 may be configured to allow the fallback functionalities to be accessed by more than one workstation 18 at a time. Each workstation 18 may then access the fallback functionalities offered by the local server 46. The functionalities may include different elements, and examples will now be provided.

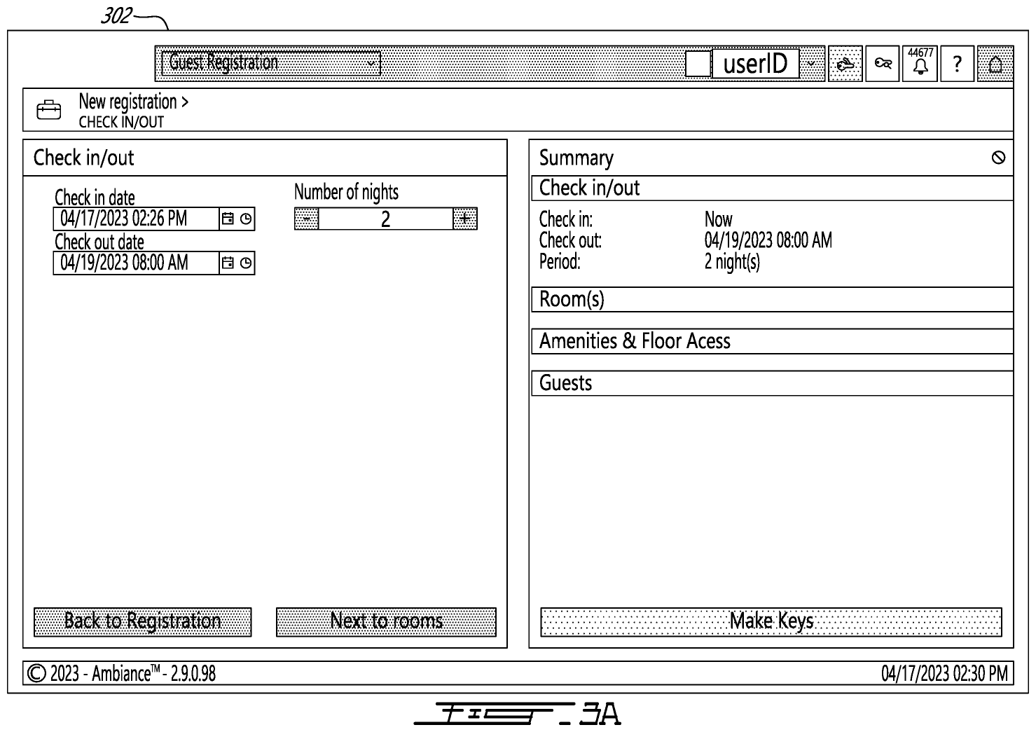

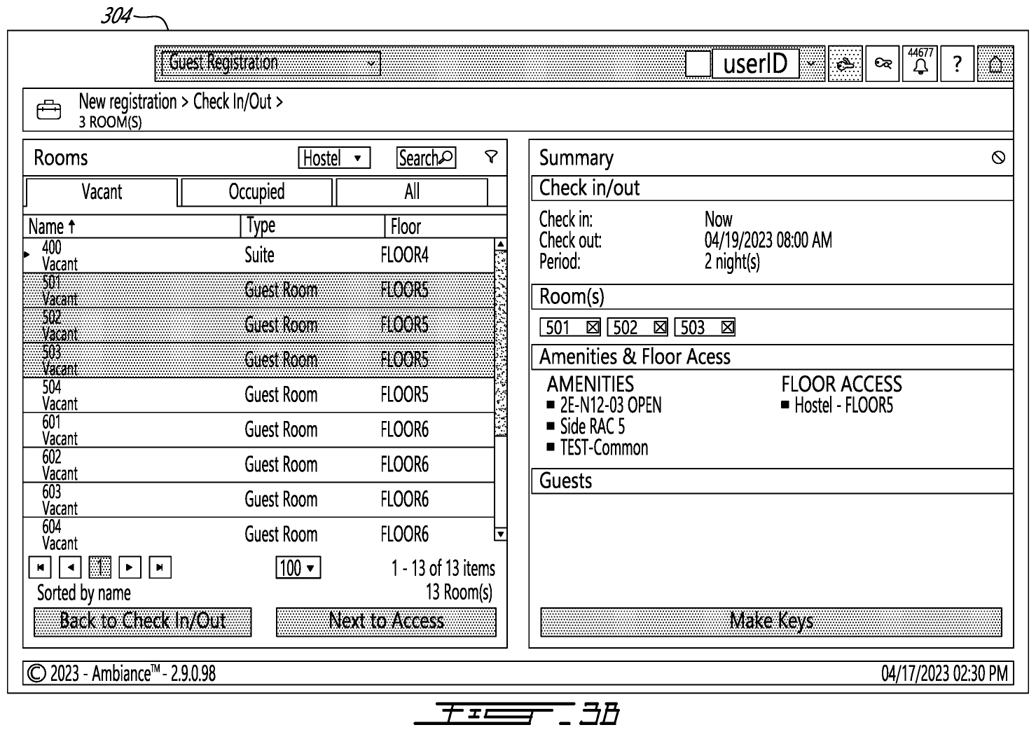

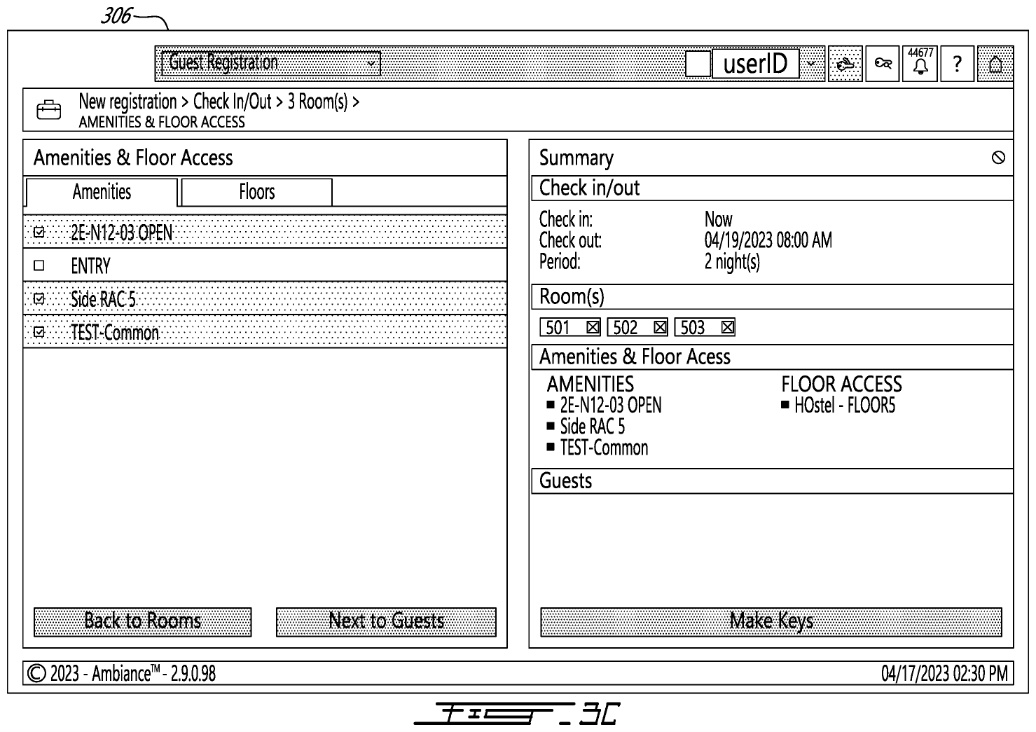

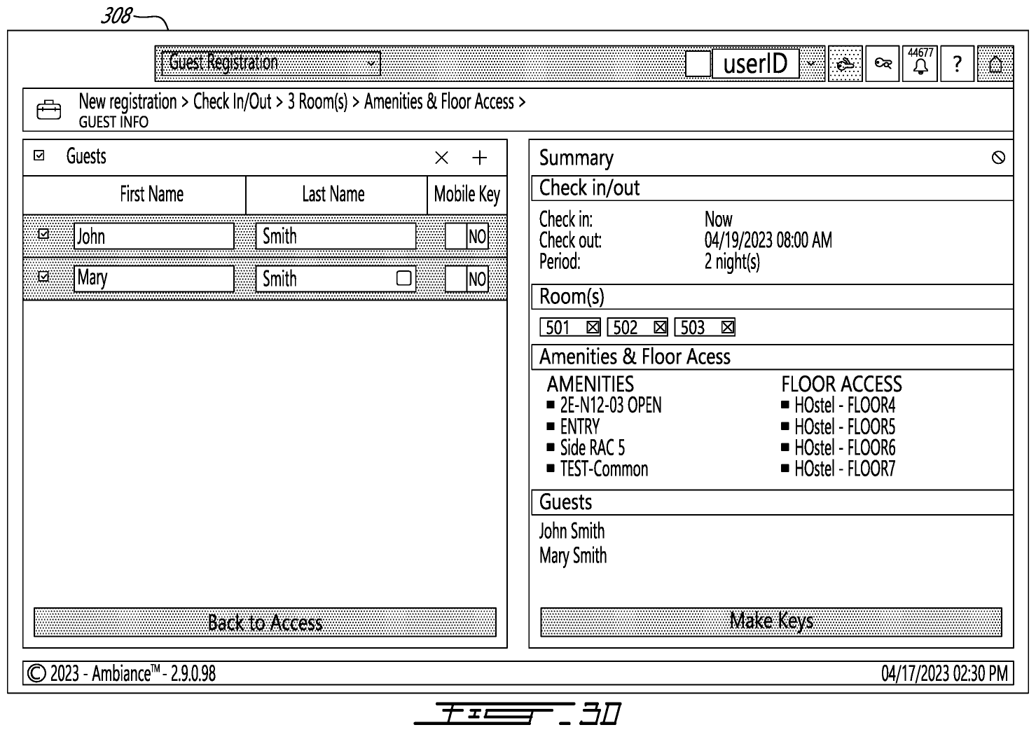

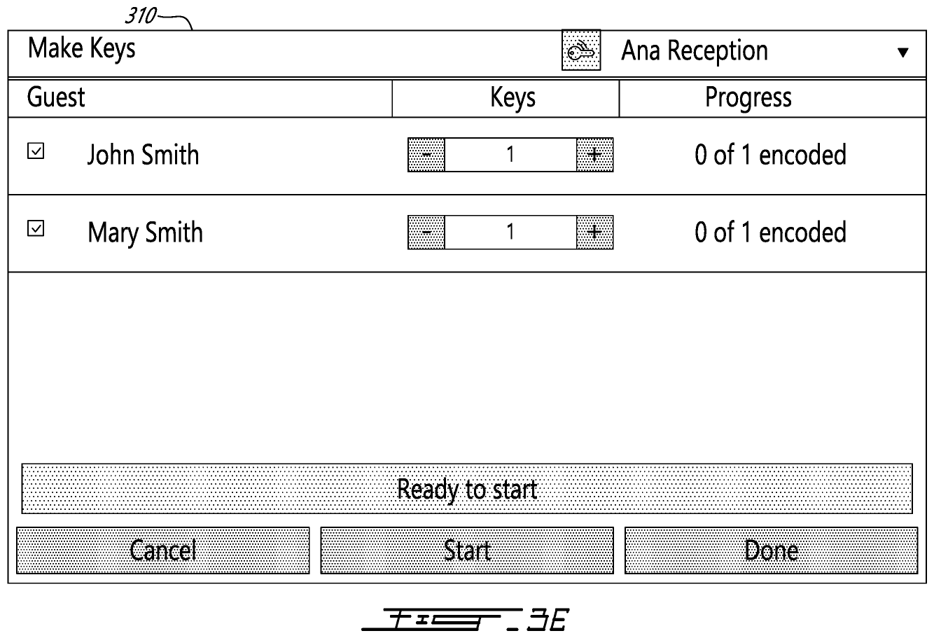

In one example, a first step in the local creation of a new booking can begin by the creation of a new booking. Once connected to the local server 46 via the LAN 26, a staff member, using a given one of the workstations 18, may access a first graphical user interface 302 which may prompt the user to provide inputs associated to the new booking. There are many different types of applications which can be adapted to create new bookings, and the sequence of graphical user interfaces presented in FIGS. 3A to 3D is but one possible example provided here for clarity and completeness, though it will be understood that variants are possible in different embodiments. In the example shown in FIGS. 3A to 3D, the local booking application 50 is a network-based application which can be accessed by premise personnel via the one or more workstations 18 located at the premises 10. The workstations 18 at the premises 10 are typically desktops or tablets, but other types of computers can be used if considered suitable to a given context.

In the example presented in FIGS. 3A to 3D, a first graphical user interface (GUI) 302, presented at FIG. 3A prompts the user to input an access period. In this case, the access period has a predefined format including a check-in (start) date and a check-out (end) date. Either the check-in and the check-out date are both entered, or one of the two is entered and a duration (e.g. number of nights) is entered to automatically calculate the other one. Once this access period data has been entered, the local booking application 50 can toggle to a second GUI 304 shown at FIG. 3B, which can be referred to as a room selection page. In this example, a roll-down menu is used to list rooms. The rooms displayed in this roll-down menu may be based on the configuration data which has previously been stored in the memory of the local server 46. In this specific example, three tabs are provided: Vacant, Occupied, and All. If the Vacant tab is selected, only the rooms which are vacant during the access period are listed in the roll-down menu. The unavailable rooms may be displayed using the Occupied tab, or all rooms, both occupied and available, may be listed via the All tab. In this example, one or more rooms may be selected from the roll-down menu, and selected rooms are highlighted in a darker color to provide user feedback. Once a sufficient number of available rooms have been selected, the user may click the access button to move onto the next GUI 306 presented at FIG. 3C. Such a GUI 306 is optional but provided for in this specific example to determine whether the guests should have access to one or more common areas, such as a gym, a pool, a terrace, or other common area. For instance, if it is known to the staff member at the workstation 18 that the group being booked for a room at the first floor is friends with a group being booked at the second floor, the staff member may choose to provide the group keycards access not only to the first floor, but also to the second floor, to make it easier for the members of the first group to visit the members of the second group. Next, guest information may be collected via a fourth GUI 308, presented at FIG. 3D. In this example, first names and last names of all guests are collected. In this embodiment, this screen is also used to determine whether any one or more of the guests have requested an electronic key, i.e. a key for the lock which is encoded into a user device, such as a smartphone, as opposed to a keycard. Indeed, an additional, optional functionality could be to encode electronic keys by the local server 46, e.g. via WiFi and associated software stored in the memory of the local server 46. The data acquired by the user inputs, including the stay period or access period, and the identification of the one or more rooms, can be stored locally, in the memory of the local server, and can be used to build a local database for instance. It can have the form of example booking data presented above for instance, or a different form.

An additional, registration step (not shown), alternately referred to as local authentication step, is typically performed to log into the local server 46 prior to granting access to the fallback functionalities. The registration step (not shown) may involve logging into the system using a username and a password or other credentials, and authenticating the user by comparing the credentials provided with the ones stored in the memory of the local server 46. In one embodiment, the credentials can also form part of the configuration data and may be the same credentials than those used to access the cloud key assignment application 24.

Following the creation of a new booking, the staff may then move on to the fallback functionality b): encoding one or more keycard associated to the new booking. This functionality may include presenting an associated GUI 310, an example of which is shown in FIG. 3E. The GUI 310 may prompt the staff member to select who the keycard is being encoded for, and to press a graphical button to begin the encoding process. When the local server 46 receives the command to begin the encoding process, the local server 46 can send the command to encode one or more keycards to the encoder 44 which is associated to the workstation 18 which is at the source of the command. Association data associating encoders 44 to workstations 18 can be included within the configuration data, for example, to allow the local server 46 to know to which encoder 18 to send the request to based on which workstation 18 is at the source of the current registration. The local server 46 can communicate with the encoders 44 via the LAN 26. The encoder 44 can execute the commanded function, and provide feedback to the local server 46 as to whether the operation has been successful or not, and the local server 46 can transfer the confirmation over to the workstation 18, which may be displayed at the GUI. Depending on the embodiment, data stemming from the second functionality may also be stored in the local database 48.

In one example, for instance, data pertaining to whether an electronic key was encoded or not, which keycard(s) were encoded, by which staff member, when, by which encoder or workstation, may be stored in the local database. One potential example of a data format collecting both booking data stemming from the local booking application 50 and the keycard key data stemming from the local access management application 52 is presented in the table below:

Example data collected at local database

| Guest | Room | Access | Common | E- | Keycard | Encoded | Date | Encoder |
|---|---|---|---|---|---|---|---|---|
| ID | ID | period | areas | key? | ID | by | information | ID |
| 4432 | 302 | April 2012- | Y | N | 125512 | Matthias | April 2009; | 3 |
| | | April 2015 | | | | L. | 16 h 42 | |
| 4464 | 203 | April 2014- | N | N | 125513 | Naomy | April 2012; | 1 |
| | | April 2015 | | | | P. | 13 h 05 | |
| 4465 | 412; | April 2014- | Y | Y | — | — | — | — |
| | 414 | April 2018 | | | | | | |
| | . . . | . . . | . . . | | . . . | . . . | . . . | |

It will be noted that the access period can correspond to an entire stay period of the guest at the premises in some embodiments.

Upon detecting a (re) connection in the connectivity, the local server 46 may disable access of the workstations 18 to its fallback functionalities. It may prevent the subsequent creation of new bookings locally, while potentially allowing booking processes which are currently underway to be finalized, or not. From that point on, the local workstations 18 are no longer able to create new bookings locally, and must therefore do so by connecting to the cloud, which may involve connecting with the PMS to create new bookings, and/or connecting with the AMS to encode new keycards in relation with a booking, for instance. In one embodiment, at this stage, the local server 46 may upload the data pertaining to the bookings performed via the fallback operations, e.g. data such as in the table above, to the cloud server 49, such as into the cloud access management database 42 via the cloud key assignment application 24. In one embodiment, the cloud key assignment application 24 may prevent the encoding of keycards until the data transfer has been confirmed to be complete. In one embodiment, the local server 46 can be configured to collect the same elements of data in the local database during the fallback functionalities than the elements of data which are maintained in the cloud access management database 42 during cloud operation, independently of whether these elements of data originate from the access management system 16 or from the property management system 14.

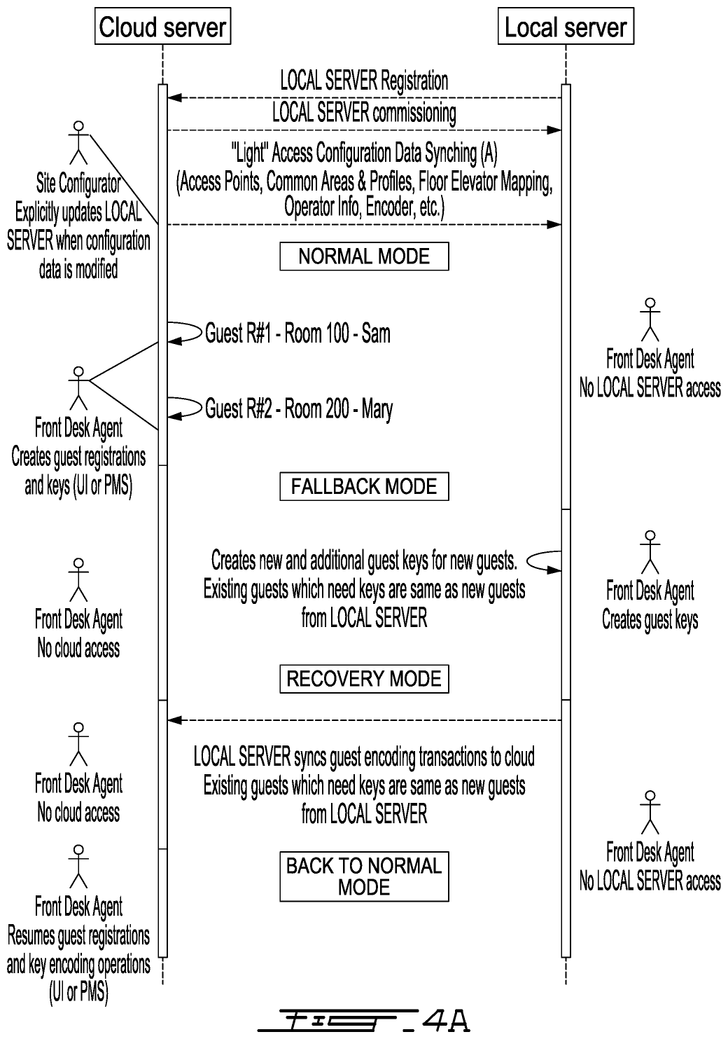

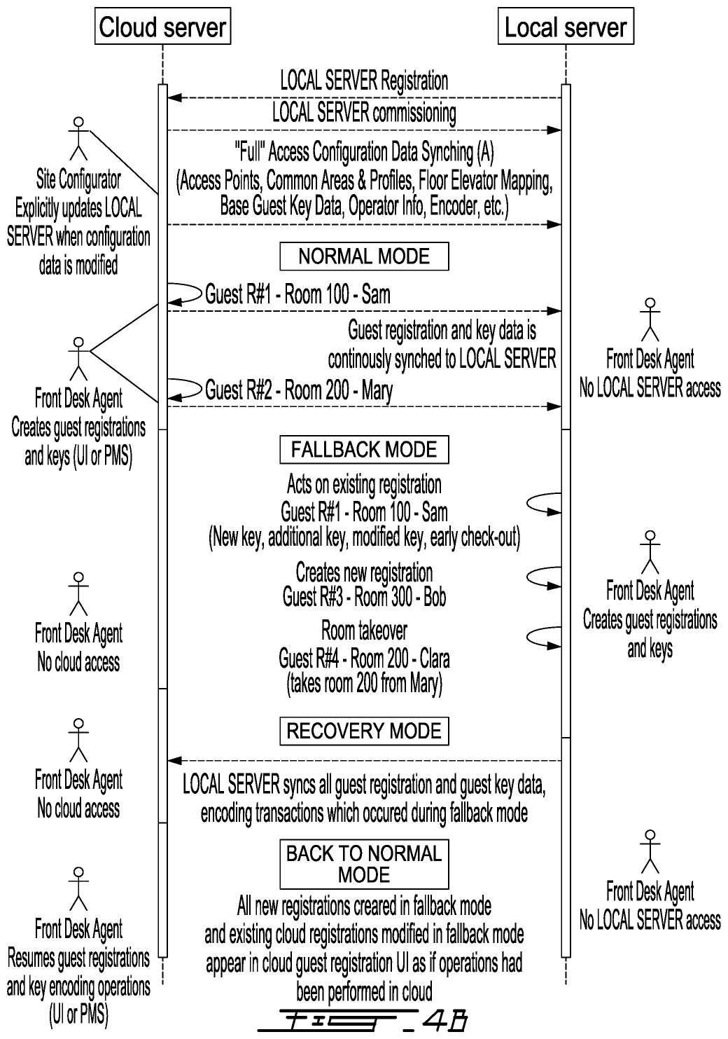

In one example, the local server may leave it to local staff members to confirm whether or not a given room is indeed vacant prior to performing a new booking. Such an example is schematized in the chart presented at FIG. 4A. In such an example, the booking data and optionally the key data may not have been generated in the memory of the local server until a first booking is completed using the fallback functionalities. The creation of the first booking may thus be considered to coincide with the creation of a table having booking data and optionally key data.

In another embodiment which will be described further below, booking data from the cloud booking database 32 may continuously be synched to the memory of the local server 46. Such an alternate example is schematized in the chart presented at FIG. 4B, in which case the cloud key assignment application 24 may have booking data received from the PMS, and may have an optional function to continuously mirror the booking data into the local database 48. Accordingly, in the event of an interruption of connectivity, the fallback functionalities may include a step of consulting the booking data in the local database, which may include booking data created before the interruption in addition to potential booking data created during the interruption, to determine which units are available, and convey this information via the graphical user interface made available to the local staff member via the corresponding workstation. Synching all the fallback transactions to the cloud server following the fallback operations may then allow the cloud server to retrieve a complete copy of all transactions. Similarly, in one embodiment, information pertaining to any new bookings performed during the fallback mode may be communicated directly by the local server to the cloud server 49, which may or may not share information pertaining to the fallback bookings to the PMS, or some information may be shared directly between the local server and the PMS. In the case of the latter, the booking data stemming from the creation of the first booking using the fallback functionalities may simply be added to the existing cloud booking data, e.g. in a same table, in which case the combined booking data may be synched back to the cloud booking database 32 upon reconnection, subsequent to which further bookings performed using the cloud services may continue to add booking data to the cloud booking database 32.

Pros of the example presented at FIG. 4B can include continued seamless guest registration operations from normal mode to/from fallback mode. Cons of the example presented at FIG. 4B can include the need to move data from the cloud server to the local server, including performing booking data synching continuously or quasi-continuously, which involves higher risk of data loss, corruption, discrepancy between could server and local server; more data transfer leads to higher cloud costs; and the solution may represent a greater development effort and a greater development risk.

Pros of the example presented at FIG. 4A can include: less access configuration data sent from the cloud server to the local server; no ongoing guest data synching to the local server every time guest registration or key encoding is performed in the cloud; less risk of data loss, corruption, or discrepancy between the cloud server and the local server; less data transfer leads to lower cloud costs; and less development effort and development risk. Cons of the example presented at FIG. 4A can include an absence of visibility of existing cloud guest registrations and room occupancy at the local server; guest registrations and guest key status in the cloud server not being updated as per guest key encoding performed on the local server during the fallback operations.

The solution presented at FIG. 4A, while bearing some advantages, may have a greater likelihood to lead to conflicts in keycards generated by the cloud server and keycards generated by the local server in the context of the fallback operations. One potential solution to address such potential inconveniences is to configure the key encoding scheme in a manner to allow cloud server-issued keycards and local server-issued keycards to invalidate each other.

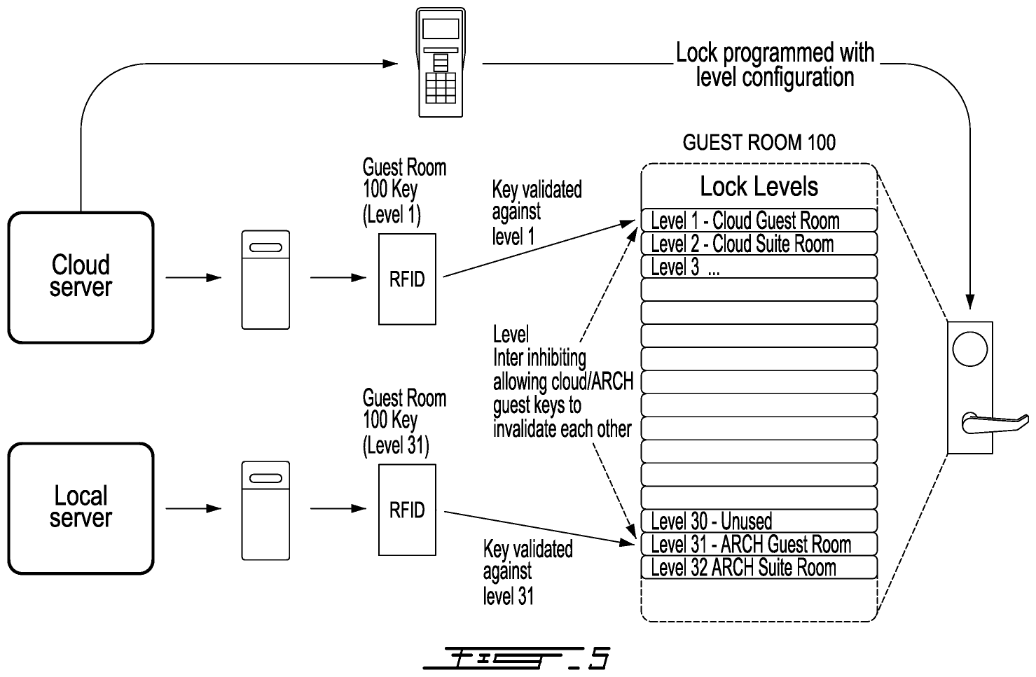

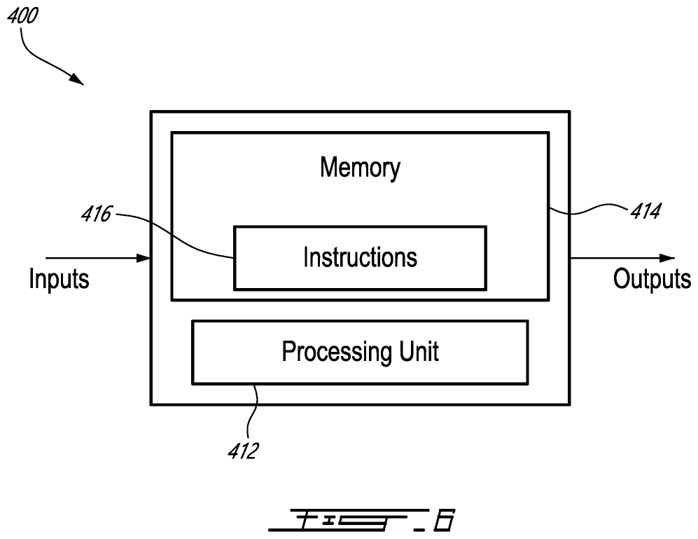

One way to achieve this will now be explained, with reference to FIG. 5. In this example, the electronic locks are programmed with an access level configuration, and key behavior and validation is access level based. More specifically, in this example, each lock/access point can be programmed with up to 32 different key/lock levels. 30 out of the 32 levels are access levels which are mainly configured for guest and staff access. Each access level is preconfigured to accept a specific “key type” and behave in lock as per defined parameterization. Each access level is fully independent but can be configured to interact with other access levels.

For the purpose of clarity and fullness of description, let us consider the following example of Level Configuration:
Level 1—Guest Room—parameterized for guest room access—used for keys issued from cloud;
Level 2—Suite Room—parameterized for guest suite access—used for keys issued from cloud;
Level 3—Guest Limited Use—parameterized for guest single shot access—used for keys issued from cloud;
Level 4—Guest Failsafe—parameterized for guest failsafe access—used for keys issued from cloud;
Level 8—Staff Emergency—parameterized for staff override deadbolt—used for keys issued from cloud;
Level 9—Staff Grand Master—parameterized for staff standard access—used for keys issued from cloud;
Level 10—Staff Master—parameterized for staff standard access—used for keys issued from cloud;
Level 11—Staff Limited Use—parameterized for staff n shot access—used for keys issued from cloud;
Level 30—Unused
Level 31—Guest Fallback Room keys—parameterized for guest room access, used during fallback functionalities
Level 32—Guest Fallback Suite Room keys-parameterized for suite room access, used during fallback functionalities

The encoding of a key can involve encoding access credentials into the keycards via an encoder. In one example, the access credentials resulting from an encoding operation controlled by the cloud server can include:
Level info (level 1 or 2)
Key index (0-4095—name of main room. E.g. Room 100)—ROOM ID
Sequence ID (0-4095—used to invalidate previous guest keys)
Key ID (1-255—used to distinguish every duplicate guest key instance)
Key creation time
Key expiration time

In this example, every time a cloud guest key is presented to the lock, lock retains the sequence ID and creation time of the key. The following new cloud guest key encoded for the same lock will be encoded with an incremented sequence ID and a different creation time. Once this new key is presented to the lock, the lock invalidates previous guest key based on this sequence ID and creation time and retains this information.

For example:
New guest key for guest room 100 (sequence ID 1)—First guest reservation R1
New guest key for guest room 100 (sequence ID 2)—Second guest reservation R2

Since guest key is new key and sequence ID 2>ID 1, first guest key is invalidated in lock.

Continuing on with this example, when the local server encodes fallback keys independently from the cloud server, the local server has no knowledge of the latest sequence ID encoded by cloud server for a given access point/room (the converse is also true). For this reason, the local server can be configured to encode guest fallback keys on different levels with its own sequence ID incrementation (e.g. level 31 & 32) so locks do not get desynchronized in regards to sequence IDs incremented in cloud vs ARCH. Moreover, in a context where the local server and the cloud server issue guest keys which invalidate each other in specific guest/suite rooms, cloud levels 1 & 2 and local levels 31 & 32 can be configured to interact with each other allowing to inhibit keys across levels.

For example:
New Cloud guest key for guest room 100 (level 1—sequence ID x)—First guest reservation R1
New ARCH guest key for guest room 100 (level 31—sequence ID y)—Second guest reservation R2

Will invalidate level 1 guest keys once presented to lock

Same for the converse, newer cloud guest keys will invalidate previous local server-encoded keycards.

In the example presented above, communications with cloud can be via HTTPS, whereas communications over local area network can be via TCP/IP. However, it will be understood that the example presented above is provided to exemplify one embodiment and that alternate embodiments are possible and well within the reach of persons having ordinary skill in the art in light of the instant specification. Indeed, for example, in one embodiment, local server can incorporate point of access to the internet, and can thus act as an edge device for the local area network. In other embodiment, it can be preferred to use a separate device for this function to avoid incorporating single point of failure. In one embodiment, additional functionalities may be integrated to the local server. For instance, in one embodiment, the local server may have the functionality of acting as a PMS bridge. For instance, a PMS FIAS server located at the premises may send and receive FIAS TCP/IP messages to/from the local server. The local server PMS bridge functionality may translate the PMS FIAS TCP/IPO messages to and from PMS LGS REST API, and send and receive PMS LGS REST API messages to and from the cloud server. In the example presented in FIG. 1, a back-of-house device, such as another workstation located at the premises, can be used to control a maintenance unit. For instance, it may encode a maintenance unit via yet another encoder.

In one example, the provisioning process may involve 1) SIMAT deploying a tenant to the cloud server, 2) a user adding the local server MAC address in the cloud server, 3) the user can connect the local server to the LAN and to the Internet, 4) the local server can connect to the cloud and register in tenant based on MAC address, 5), the local server can be configured so it can be used to sync data back and forth with the cloud server, 6) Simat may monitor local servers assigned to tenants. In such an example, the provisioning process does not involve SIMAT directly. SIMAT's role, if any, may be passive and used to monitor which ARCH devices are associated with which tenants.

In another example, provisioning of the local server can be provided by a SIMAT operator. The SIMAT operator may deploy the cloud server tenant with a local server activation key. A user can then obtain a unique local server activation key, connect to the local server on the network and input the unique local server activation key. The local server may then connect and register into SIMAT with a MAC X activation key. The local server MAC X can be added to the local server buffer and associated to the corresponding tenant based on the activation key. SIMAT may reject the local server registration if no matching local server activation key is found. The SIMAT operator can then authorize the local server MAC X for the tenant. The SIMAT can configure the local server with the tenant URL and certificate. The local server can register into the tenant, at the cloud server. The user may then authorize the local server so that it can be used. A local server with invalid default certificate may fail to connect and register with SIMAT.

It will be understood that the expression “computer” as used herein is not to be interpreted in a limiting manner. It is rather used in a broad sense to generally refer to the combination of some form of one or more processing units and some form of memory system accessible by the processing unit(s). The memory system can be of the non-transitory type. The use of the expression “computer” in its singular form as used herein includes within its scope the combination of a two or more computers working collaboratively to perform a given function. Moreover, the expression “computer” as used herein includes within its scope the use of partial capabilities of a given processing unit. Example computers include desktop, laptop, smartphone, smart watch, less elaborated controller devices, etc.

A processing unit can be embodied in the form of a general-purpose micro-processor or microcontroller, a digital signal processing (DSP) processor, an integrated circuit, a field programmable gate array (FPGA), a reconfigurable processor, a programmable read-only memory (PROM), to name a few examples.

The memory system can include a suitable combination of any suitable type of computer-readable memory located either internally, externally, and accessible by the processor in a wired or wireless manner, either directly or over a network such as the Internet. A computer-readable memory can be embodied in the form of random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) to name a few examples.

A computer can have one or more input/output (I/O) interface to allow communication with a human user and/or with another computer via an associated input, output, or input/output device such as a keyboard, a mouse, a touchscreen, an antenna, a port, etc. Each I/O interface can enable the computer to communicate and/or exchange data with other components, to access and connect to network resources, to serve applications, and/or perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, Bluetooth, WiMAX), SS7 signaling network, fixed line, local area network, wide area network, to name a few examples.

It will be understood that a computer can perform functions or processes via hardware or a combination of both hardware and software. For example, hardware can include logic gates included as part of a silicon chip of a processor. Software (e.g. application, process) can be in the form of data such as computer-readable instructions stored in a non-transitory computer-readable memory accessible by one or more processing units. With respect to a computer or a processing unit, the expression “configured to” relates to the presence of hardware or a combination of hardware and software which is operable to perform the associated functions. Different elements of a computer, such as processor and/or memory, can be local, or in part or in whole remote and/or distributed and/or virtual.

The methods and systems of the present disclosure may be implemented in a high level procedural or object oriented programming or scripting language, or a combination thereof, to communicate with or assist in the operation of a computer system, for example the local server 46. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit 412 of the computing device 400, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments. The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

As can be understood, the examples described above and illustrated are intended to be exemplary only. The scope is indicated by the appended claims.

1. A local server located at a premises, the premises having at least one unit, the premises having at least one electronic lock, the premises having at least one workstation, the premises having at least one encoder, the local server comprising a memory and a processor, the memory having stored thereon configuration data for the premises and instructions executable by the processor to:
monitor a connectivity to a cloud server to detect an interruption in the connectivity and to detect a connection in the connectivity;
when detecting the interruption, enable local creation of at least one booking including, for each of the at least one booking:
creating the at least one booking based on the configuration data and based on inputs received from a given one of the at least one workstation, including storing booking data into the memory, the booking data comprising an access period at the premises; and
encoding at least one access device via at least one of said at least one encoders, including granting the at least one access device access, for the access period, to at least one of the at least one unit; and
when detecting the connection, disable local creation of at least one booking.

2. The local server of claim 1 wherein the at least one workstation includes a plurality of workstations and wherein the at least one encoder includes a plurality of encoders, wherein the instructions are executable to repeat the creating and encoding for a plurality of bookings based on the configuration data and inputs from different ones of the plurality of workstations, including adding the booking data generated by the creation of each one of the plurality of bookings to a table in the memory, and repeating the encoding for each one of the plurality of bookings via different ones of the plurality of encoders, the different ones of the plurality of encoders associated to different ones of the plurality of workstations.

3. The local server of claim 2 including, for a first one of the plurality of bookings, creating the table and including the corresponding booking data as a first line of the table.

4. The local server of claim 2 wherein the encoding includes determining which one of the plurality of encoders to send an encoding command to based on association data, the association data associating different ones of the plurality of encoders to different ones of the plurality of workstations, the association data forming part of the configuration data.

5. The local server of claim 1 wherein the instructions are further executable to, when detecting the interruption, enable consultation of the booking data via the at least one workstation.

6. The local server of claim 5 wherein the instructions are further executable to, when detecting the interruption, enable the encoding of at least one replacement access device via the at least one encoder.

7. The local server of claim 5 wherein the instructions are further executable to, when detecting the interruption, enable modification of the booking data via the at least one workstation.

8. The local server of claim 1 wherein the instructions are further executable to, when detecting the connection, communicating the booking data to the cloud server via a telecommunications network.

9. The local server of claim 8 wherein the instructions are further executable to delete the booking data from the local server subsequently to said communicating the booking data to the cloud server.

10. The local server of claim 8 wherein said creating includes, for each one of the at least one booking, storing key data in association with corresponding booking data in the memory; and wherein the instructions are further executable by the processor to, when detecting the connection, communicating the key data to the cloud server via the telecommunications network.

11. The local server of claim 10 wherein the key data includes an identifier of the at least one access device, an identifier of a staff member logged into the local server and responsible for the encoding, and date information at which the encoding was performed.

12. The local server of claim 1 wherein said granting further includes granting the at least one access device access, for the access period, to at least one of a floor, a pool, a gym, a food area, a conference area, and a terrace.

13. The local server of claim 1 wherein said enabling the local creation of at least one booking further includes receiving a login request from the given one of the at least one workstation over a local area network, authenticating the login request against the configuration data, and granting access to the creating and encoding contingent upon the authenticating the login request.

14. The local server of claim 1 further including, for each one of the at least one booking receiving a confirmation of a success of the encoding from the given one of the at least one encoder via a local area network, and communicating the confirmation of the success of the encoding to the given one of the at least one workstation via the local area network.

15. The local server of claim 1 wherein the instructions are further executable to copy cloud booking data stemming from previous bookings from the cloud server to the memory, including updating the cloud booking data in the memory to reflect changes in the cloud booking data at the cloud server, said storing booking data including forming offline booking data including adding the booking data to the cloud booking data in the memory.

16. The local server of claim 1 wherein said encoding includes encoding the at least one access device at a level which is different from when the at least one access device is encoded via the cloud server.

17. The local server of claim 16 wherein said access credentials released by the local server are first level access credentials, said access credentials released by the cloud server are second level access credentials, the second level access credentials being different from the first level access credentials, wherein presenting one of the first level access credentials at one of the electronic locks blocks the access at this one of the electronic locks for one of the second level access credentials.

18. The local server of claim 1 wherein the at least one access device comprises at least one keycard.

19. The local server of claim 1 wherein the at least one access device comprises at least one mobile credential.

20. The local server of claim 1 wherein the instructions are further executable to translate TCP/IP messages received from a PMS server to REST API messages, and to send the REST API messages.

21. A method of encoding access devices for controlling access to at least one unit located at a premises, the premises having at least one workstation and at least one encoder for encoding the at least one access device, the method comprising:
at the premises, monitoring a connectivity to a cloud server to detect an interruption in the connectivity and to detect a connection in the connectivity;
when detecting the interruption, enabling local creation of at least one booking including, for each of the at least one booking:
creating the at least one booking based on a configuration of the premises and based on inputs received from a given one of the at least one workstation, including storing booking data into a memory, the booking data comprising an access period at the premises; and
encoding at least one of the access devices via a given one of the at least one encoder, including granting the at least one access device access, for the access period, to at least one of the units; and
when detecting the connection, disabling the local creation of the at least one booking.

22. The method of claim 21 wherein said creating includes, for each one of the at least one booking, storing key data in association with corresponding booking data in the memory; further comprising, when detecting the connection, communicating the key data and the booking data to the cloud server via a telecommunications network.

23. A method of releasing access credentials for providing access to units controlled by electronic locks located at a premises, the premises having a workstation, the method comprising:
at the premises, monitoring connectivity to a cloud server to detect an interruption in the connectivity and to detect a connection in the connectivity;
when detecting the interruption, enabling local creation of bookings by a local server, the local server having a memory and configuration data stored in the memory, including, for each of the bookings:
creating the booking based on the configuration data and based on inputs received from the workstation, including storing booking data stemming from the booking into the memory, the booking data including an access period at one or more of the units;
releasing access credentials, including granting access, for the access period, to the one or more of the units controlled by one or more of the electronic locks; and
when detecting the connection, disabling the local creation of bookings.

24. The method of releasing access credentials of claim 23 wherein said releasing access credentials includes commanding an encoder located at the premises to encode one or more keycards with the access credentials.

25. The method of releasing access credentials of claim 23 wherein said releasing access credentials includes transmitting the access credentials to a customer device.

26. The method of releasing access credentials of claim 23, further comprising a cloud server releasing access credentials over a telecommunications network prior to detecting the interruption in the connectivity.

27. The method of claim 26 wherein said access credentials released by the local server are first level access credentials, said access credentials released by the cloud server are second level access credentials, the second level access credentials being different from the first level access credentials, wherein presenting one of the first level access credentials at one of the electronic locks blocks the access at this one of the electronic locks for one of the second level access credentials.

28. The method of claim 26 further comprising copying cloud booking data associated to the encoding by the cloud server to the memory of the local server, including updating the cloud booking data in the memory to reflect changes in the cloud booking data at the cloud server, said storing booking data including adding the booking data to the cloud booking data in the memory to form offline booking data.

29. The method of claim 28 further comprising, when detecting the connection, the local server uploading the offline booking data to the cloud server.
